(19) United States
(12) Patent Application Publication
(10) Pub. No.: US 2002/0043014 A1
(43) Pub. Date: Apr. 18, 2002

(54) Fishing rod holder

(76) Inventor: Robert A. Kondash, Townsend, MT (US)

Correspondence Address: Michael S. Kakuk, 1717 Harrison Ave., Helena, MT, 59601, US

(21) Appl. No.: 09/771,099

(22) Filed: Jan. 26, 2001

Related U.S. Application Data
(60) Provisional application No. 60/172,521, filed on Dec. 17, 1999.

(51) Int. Cl. A01K 85/01; A01K 93/00; A01K 97/12

(52) U.S. Cl. 43/17

(57) ABSTRACT

An improved ice fishing apparatus that includes a vertical support member, a horizontal support member, a reel, and a reel activated fish strike indicator mechanism. Both the vertical and horizontal support members pivot to allow easy storage and transportation and the vertical support member is designed to hold the reel submerged under water when in use.

### BACKGROUND OF THE INVENTION

1. Field of the Invention

The present invention relates to an improved fishing rod holding and supporting device more particularly including a rod holder, a support member, and a base for land operation and a base for aquatic vessel operation. Both the rod holder and the support member pivot and are securable thereby allowing the fishing rod to be placed in the most advantageous position for catching fish.

2. Description of the Prior Art

Many and various types of fishing rod holders are known in the art. Most suffer from the same short-comings: inability to adjust the fishing rod tip for the immediate situation; inability to use the same rod holder on land and on the water; instability when used on land; inconvenient height, usually too low to the ground, when used either on land or water; inconvenient to carry or transport.

### SUMMARY OF THE INVENTION

It is the intent of the present invention to cure the above listed short-comings and inadequacies of design by providing a fishing rod holder that is:

adjustable from a number of locations;

stable when used either on land or on the water in a boat;

located at a comfortable level for the seated or standing fisherman;

able to hold the fishing rod securely;

easy to operate;

efficiently designed and easy to maintain; and

long-lasting and affordable to produce and purchase.

### BRIEF DESCRIPTION OF THE DRAWINGS

The present invention will become more fully understood from the detailed description which is given below and the accompanying drawings which are given by way of illustration only and are not limitative of the present invention. The drawings are briefly described as follows:

FIG. 1 provides various views of the preferred embodiment overall;

FIG. 2 provides a plan view of the bottom of the land base;

FIG. 3 provides a view of the legs;

FIG. 4 provides a view of the flange on the top side of the land base;

FIG. 5 provides a plan view of the land base;

FIG. 6 provides various views of support member;

FIG. 7 provides a view of the aquatic base;

FIG. 8 provides a view of the flange on the rod holder member; and

FIG. 9 provides a view of the rod holder member.

### DETAILED DESCRIPTION OF THE PREFERRED EMBODIMENT

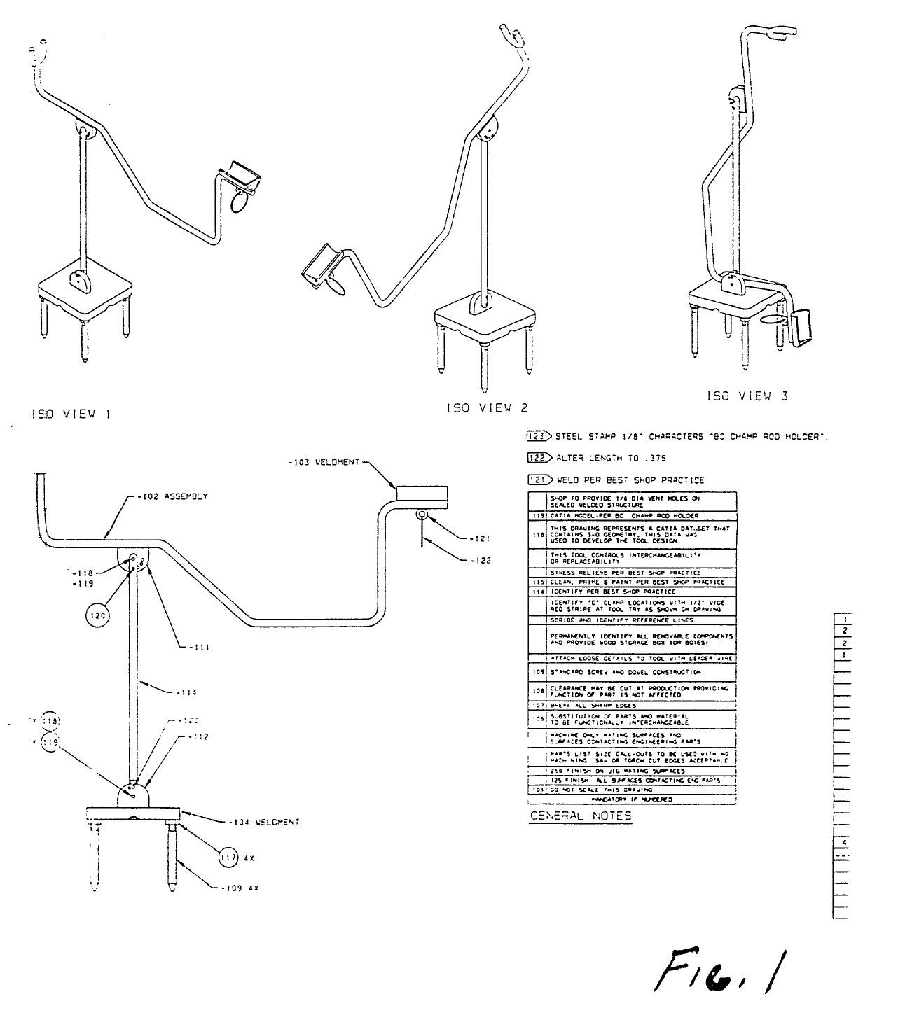

With reference now to the drawings, and in particular to FIG. 1 thereof, the preferred embodiment of the new and improved multi-environment, vertically adjustable, universal rod holder member embodying the principals and concepts of the present invention will be described.

The preferred embodiment of the present invention comprises a plurality of components. In their broadest context, such components include a base for land use, a base for aquatic vessel use, a support member, a base and support member attaching means, a rod holder member, and a support member and rod holder member attaching means. Such components are individually configured and correlated with respect to each other to provide a structure used for holding a fishing rod in a desired position for use when fishing.

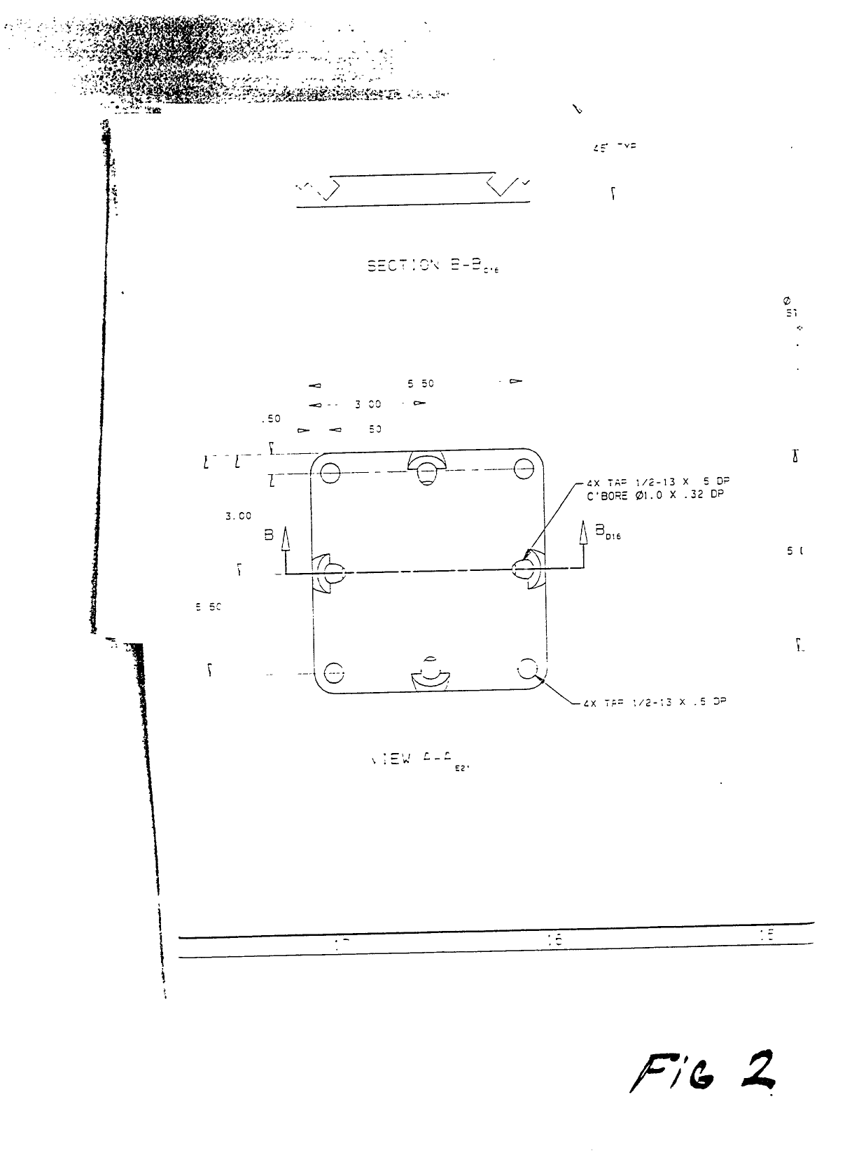

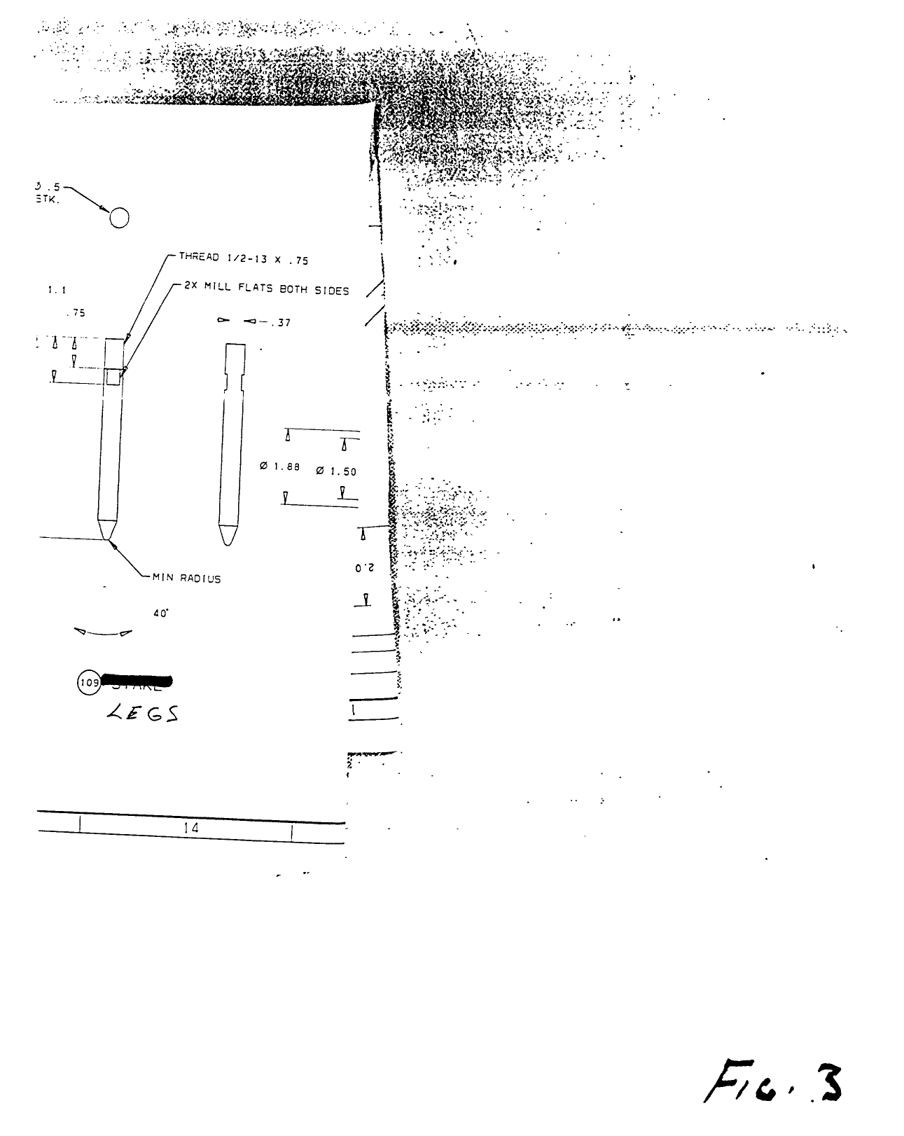

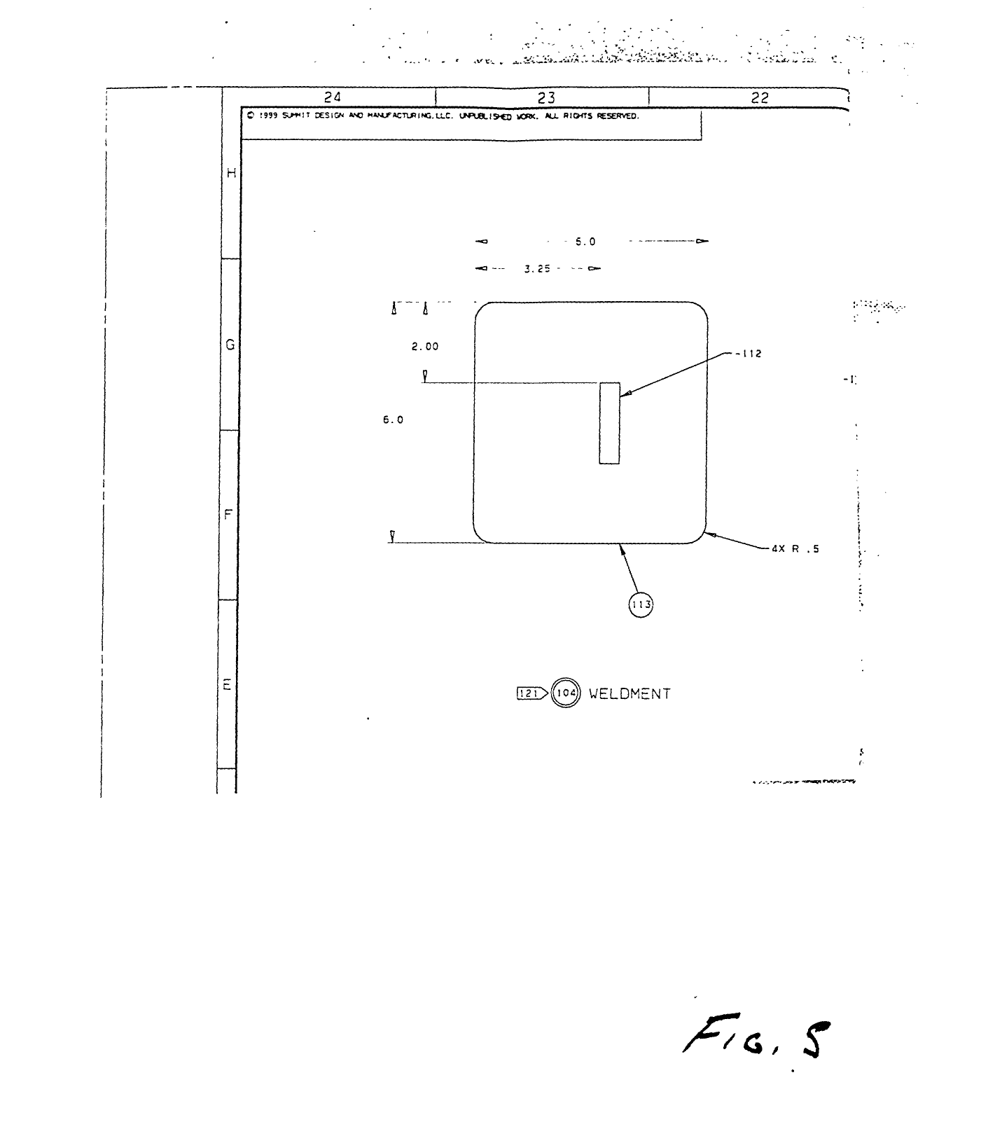

Specifically, the present invention includes a base for land use (FIG. 2—bottom side and FIG. 5—top side). The preferred land base is planer and square in structure and formed of a rigid non-corrodeable metal material. The land base has four inwardly threaded tubular receptacles at a 90-degree angle to one planer side (FIG. 2—bottom side) of the land base. One receptacle is at each corner of the bottom side of the land base. The land base has another four inwardly threaded tubular receptacles at a 45-degree angle to the bottom side of the land base. One 45-degree receptacle is at each midway point between each of the 90-degree angle receptacles. All eight receptacles are on the bottom side of the land base and receive a threaded stake-type attachment or leg (FIG. 3). These legs are made of a rigid non-corrodeable metal material and secure the land base into the land when inserted into either the 90-degree or the 45-degree tubular receptacles.

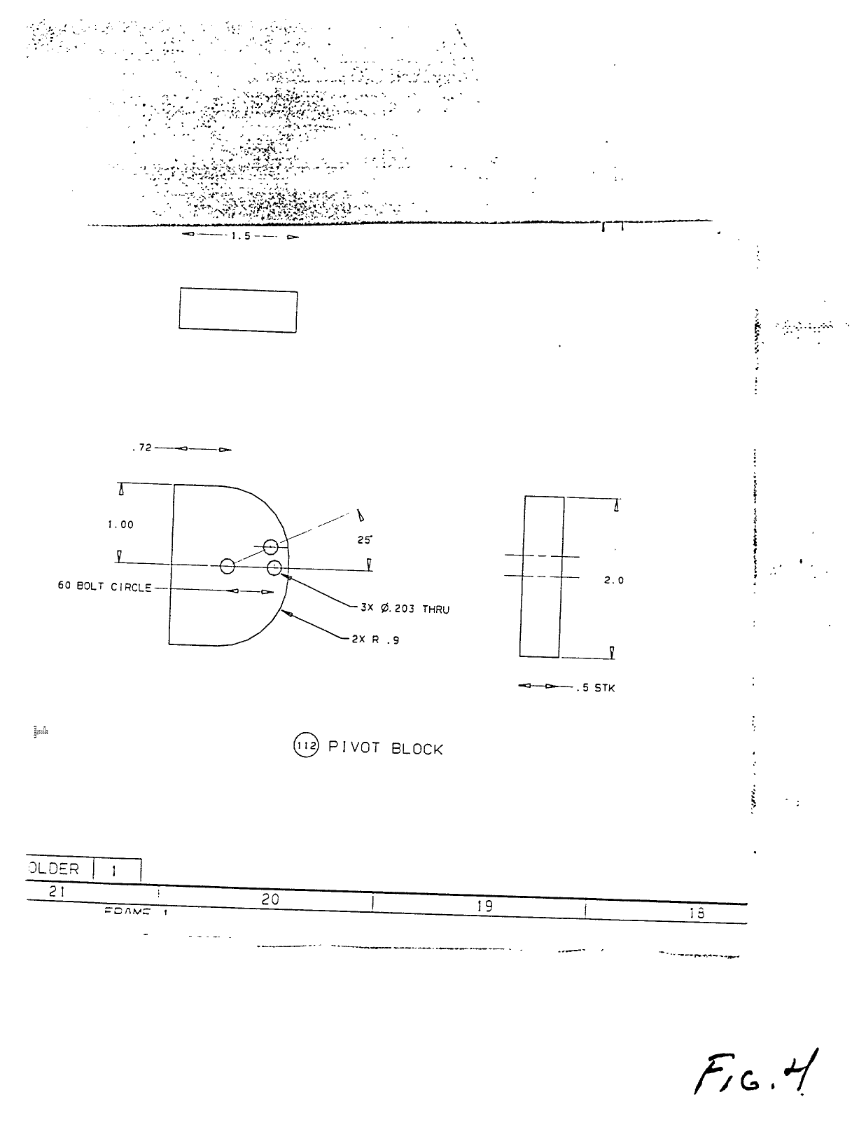

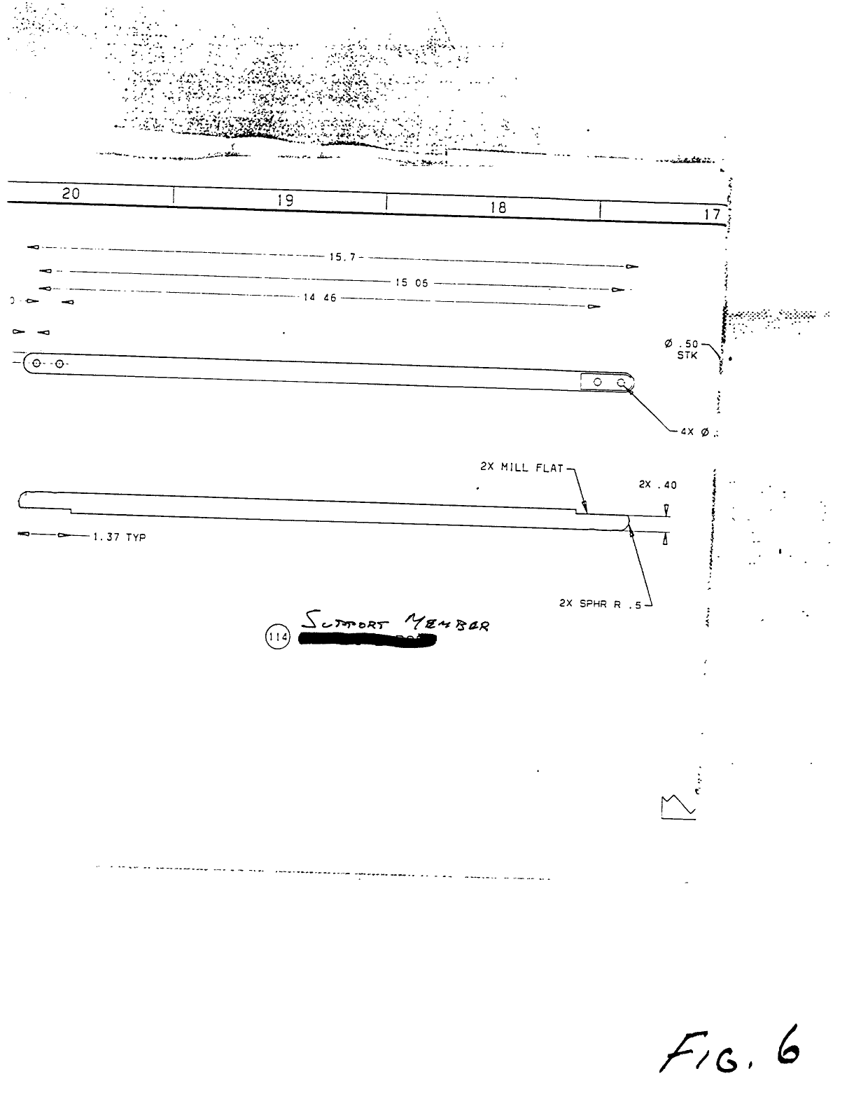

A flange (FIG. 4) protrudes from the upper planer side of the land base (FIG. 5—top side) to which is attached a support member (FIG. 6). The support member is made of a rigid non-corrodeable metal material. The land base flange has a plurality of holes drilled into the flange. These holes run parallel to the upper side of the land base. The lower end of the support member is attached to the land base flange by means of a screw that allows the support member to pivot laterally in a lever-like manner on the land base. The support member is secured on the land base in the desired position for fishing by means of a cotter pin through the support member and into the land base flange in a particular hole.

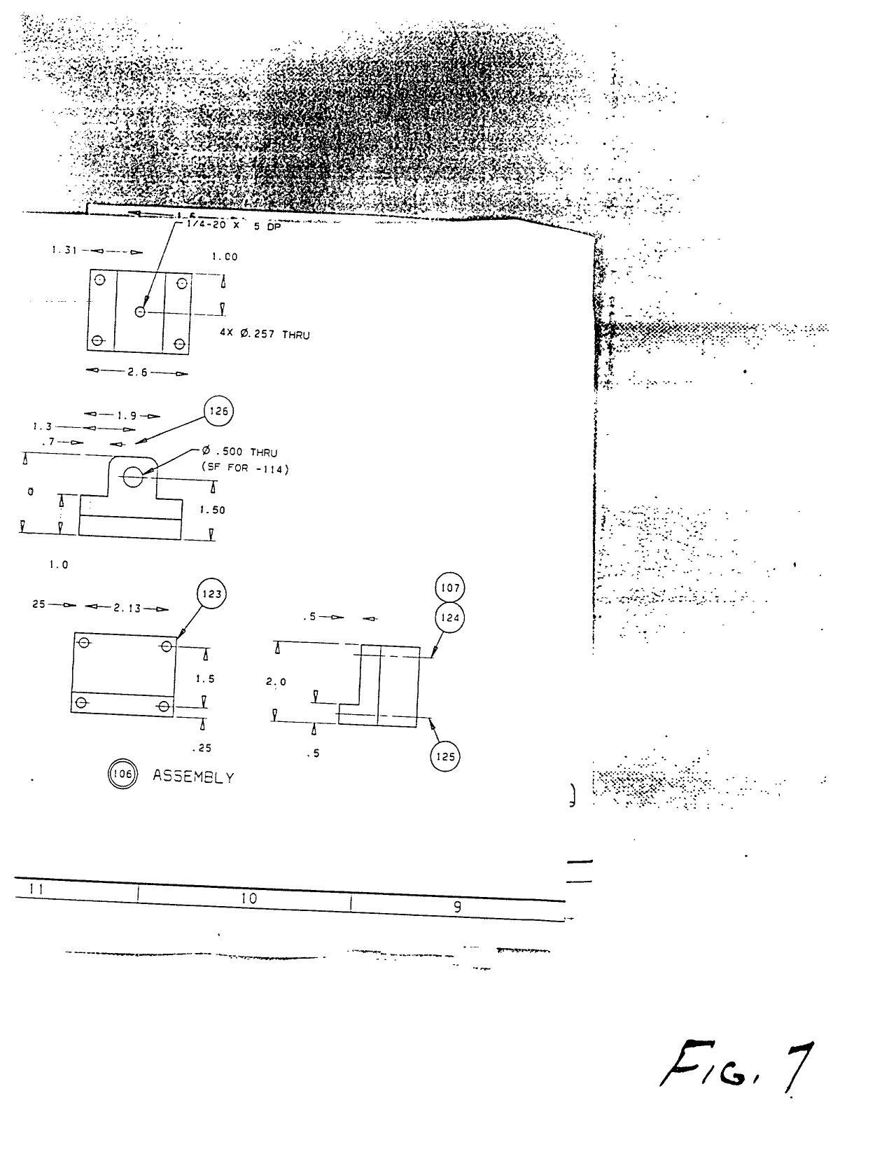

Additionally, the present invention includes a base for aquatic vehicle use (FIG. 7). The aquatic base is made of a rigid non-corrodeable metal material and is of a design to allow it to be fixed to the gunwale of an aquatic vessel by means of four attaching screws. The attaching screws run horizontally through the aquatic base, through four non-threaded holes, and into the aquatic vessel. The aquatic base also has a hole running through the aquatic base from top to bottom at a 90-degree angle to the attaching screws. This hole receives a support member. The support member is secured at the desired height for fishing by means of a hand-tightened screw. This hand-tightened screw runs horizontally into the aquatic base, through a threaded hole, and into the support member receiving hole.

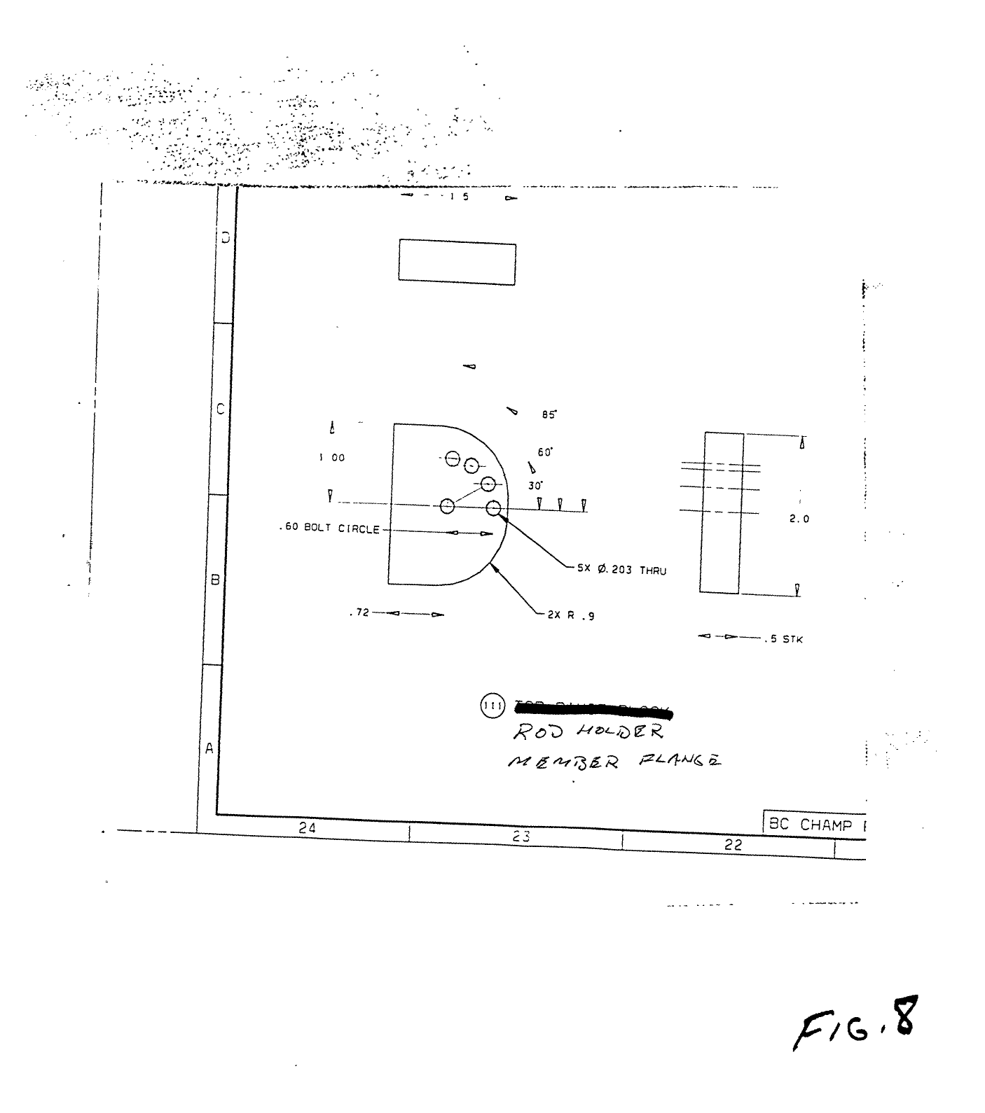

The upper end of the support member, the lower end of the support member being attached to either the land or aquatic base, attaches to a flange (FIG. 8) located on the rod holder member, by means of a screw that allows the rod holder member to pivot vertically on the support member, that is one end of the rod holder member goes up while the other end goes down. The rod holder member flange has a plurality of holes. The rod holder member is secured on the support member in the desired position for fishing by means of a cotter pin through a particular hole in the rod holder member flange and into the support member.

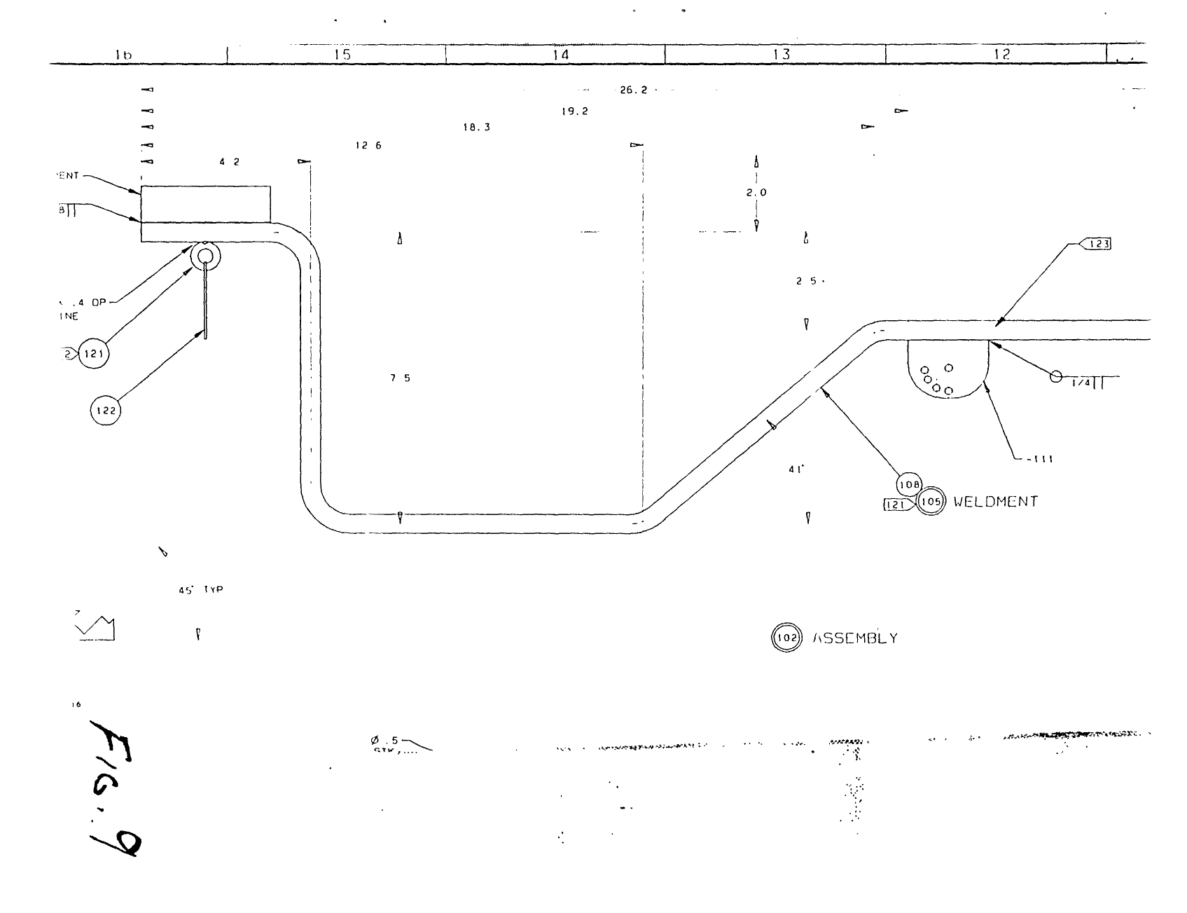

The present invention also includes a rod holder member (FIG. 9). The rod holder member is made of a rigid non-corrodeable metal material and is comprised of one trough-like end to receive the handle of a fishing rod, a u-shaped end to receive the rod end of a fishing rod, and a rod to connect both ends of the rod holder member. The connecting rod is designed to accept a multitude of fishing rod designs through the use of a deep offset.

The handle of a fishing rod is secured to the rod holder member by means of an elastic band that encompasses the top of the rod holder member trough. This elastic band can be stretched and placed over the fishing rod handle when the holder is in use and then stretched to remove the band from the trough to remove the fishing rod. (FIG. 9, specifically encircled #122, shows the elastic band in the flaccid, non-use, position.)

What is claimed is:

1. A fishing rod holder comprising of:
a. a rod holder member designed to accept a multitude of fishing rods and fishing reels;
b. a means of attaching the rod holder member to a support member, the attaching means allowing the rod holder member to pivot vertically along its axis, that is, one end of the rod holder member goes up while the other end goes down, and to be fixed at a selected position; and
c. a support member with a means of attaching the support member to a secure surface.

2. The fishing rod holder described in claim 1 further including:
a. a base whereby the fishing rod holder can be used from the land;
b. a means for attaching the land base to the support member, the attaching means allowing the support member to pivot laterally and to be fixed at a selected position; and
c. a plurality of legs having opposed ends one end of each leg being connected to the base at such distance as to provide stability to the base.

3. The fishing rod holder described in claim 2 whereby the base has a plurality of receptacles which allow for the legs to be attached either vertically or at an angle whereby the stability of the base can be maximized.

4. The fishing rod holder described in claim 1 further including:
a. a base whereby the fishing rod holder can be used from an aquatic vessel; and
b. a means of attaching the aquatic base to the support member and a means of attaching the aquatic base to an aquatic vessel.
